(19) United States
(12) Patent Application Publication
(10) Pub. No.: US 2009/0050002 A1
(43) Pub. Date: Feb. 26, 2009

(54) Liquid Supply Apparatus

(76) Inventor: Hiroyuki Sugiyama, Tokyo (JP)

Correspondence Address: BIRCH STEWART KOLASCH & BIRCH, PO BOX 747, FALLS CHURCH, VA, 22040-0747, US

(21) Appl. No.: 11/886,583

(22) PCT Filed: Apr. 26, 2006
(86) PCT No.: PCT/JP2006/308694

§ 371 Date: Sep. 18, 2007

(30) Foreign Application Priority Data
Apr. 27, 2005 (JP) 2005-128888

(51) Int. Cl. B41L 13/18

(52) U.S. Cl. 101/123

(57) ABSTRACT

A liquid supply apparatus which can supply a liquid from a liquid supply cylinder to a sheet, held on an impression cylinder, satisfactorily at a low cost even at a high speed is provided. The liquid supply apparatus comprises: an impression cylinder (40) supported rotatably and having a notch portion (40a) formed in an outer peripheral surface thereof; a gripper device (41) disposed within the notch portion of the impression cylinder for holding a sheet (1); and a rotary screen device (27) including a hollow cylinder (50) supported rotatably and supporting a screen (55) having holes formed in a circumferential portion thereof, and a squeegee (51) located within the hollow cylinder, and making a sliding contact with an inner peripheral surface of the screen for supplying special ink or the like, stored inside the screen, to the sheet held by the gripper device through the holes of the screen, the rotary screen device further including: a squeegee guide (52) supported in the hollow cylinder such that curved surfaces formed at least at opposite end portions of the squeegee guide communicate with the inner peripheral surface of the plate material.

### TECHNICAL FIELD

This invention relates to a liquid supply apparatus for supplying a liquid, such as ink or varnish, to a sheet, which is held on an impression cylinder, to carry out printing or coating. The liquid supply apparatus is effective, particularly, when applied to a screen printing unit of a printing press for performing screen printing on a sheet.

### BACKGROUND ART

A conventional printing press for performing screen printing has a rotary screen device equipped with a squeegee inside a hollow cylinder supporting, in an arcuate form, a thin screen (comprising stainless steel, nickel or the like) having small holes corresponding to patterns etched therein. In the rotary screen device, ink, which has been supplied from an ink fountain supported by a frame to the interior of the hollow cylinder, is pushed out from the small holes of the screen via the squeegee, while the hollow cylinder is being rotated, whereby printing corresponding to the patterns can be done on the sheet. Screen printing, which uses such a rotary screen device, enables a special ink or the like to be applied in a thick layer. Thus, screen printing is applied when giving a quality appearance, a quality touch, etc.

When screen printing is carried out using the rotary screen device, a gripper portion in a gripper device of the impression cylinder in contact with the screen supported by the hollow cylinder of the rotary screen device may protrude from the outer peripheral surface of the impression cylinder. In this case, the gripper portion may contact the screen of the rotary screen device to damage the screen.

To avoid the above risk, Patent Document 1 shown below, for example, takes the following measures: The gripper and gripper pad of the gripper device are disposed within a notch portion of the impression cylinder to keep them from protruding from the outer peripheral surface of the impression cylinder. Also, an openable and closable cover is provided for covering the notch portion. When the sheet is held or released, the cover is also opened or closed in synchronism with the opening action or closing action of the gripper. This operation makes it possible to hold or release the sheet, and prevents the screen in the rotary screen device from sagging into the notch portion of the impression cylinder, or prevents damage to the screen due to its contact with the gripper portion (protrusion).

Patent Document 1: Officially Published Patent Gazette No. 2000-504643

### DISCLOSURE OF THE INVENTION

### Problems to be Solved by the Invention

The impression cylinder described in the above-mentioned Patent Document 1, however, is rotated while the large cover covering the entire notch portion is being opened or closed. If the impression cylinder is rotated at a high speed, therefore, the cover may vibrate to deteriorate the surface uniformity or flushness of the outer periphery of the impression cylinder, when the cover closes the notch portion. Thus, it is difficult to apply the above impression cylinder to high speed printing. Moreover, the vibrating cover may also contact the hollow cylinder of the rotary screen device, damaging the hollow cylinder.

Such problems are not limited to the case where the rotary screen device is used for printing the sheet with special ink or the like in a thick layer. These problems can occur similarly in a case where a liquid is supplied from a liquid supply cylinder to the sheet held on the impression cylinder, such as a case where the rotary screen device is used for coating a sheet with varnish or the like.

The present invention has been accomplished in light of the above-described problems. It is an object of the invention to provide a liquid supply apparatus which can supply a liquid from a liquid supply cylinder to a sheet, held on an impression cylinder, satisfactorily at a low cost even when the impression cylinder is rotated at a high speed.

### Means for Solving the Problems

A liquid supply apparatus according to the present invention, for solving the above-mentioned problems, is a liquid supply apparatus, comprising:

an impression cylinder supported rotatably and having a notch portion formed in an outer peripheral surface thereof;

sheet holding means disposed within the notch portion of the impression cylinder for holding a sheet; and
a rotary screen device including a hollow cylinder which is supported rotatably and which supports a plate material having holes formed in a circumferential portion of the plate material, and a squeegee which is located within the hollow cylinder, and which makes a sliding contact with an inner peripheral surface of the plate material for supplying a liquid stored inside the plate material to the sheet held by the sheet holding means through the holes of the plate material,

the rotary screen device further including a guide member which is supported in the hollow cylinder such that curved surface portions formed at least at opposite end portions of the guide member communicate with the inner peripheral surface of the plate material.

The liquid supply apparatus is characterized in that the guide member has a continuous curved surface having a larger radius of curvature than a radius of curvature of the inner peripheral surface of the plate material.

The liquid supply apparatus is also characterized in that the hollow cylinder is equipped with a plate material support portion for supporting the plate material, and a guide member support portion for supporting the guide member.

The liquid supply apparatus is also characterized in that the guide member is formed from a crescent rigid body.

The liquid supply apparatus is also characterized in that the guide member has a continuous curved surface between a pair of the curved surface portions of the guide member.

The liquid supply apparatus is also characterized in that the squeegee elastically deforms between a first squeegee state where the squeegee makes a sliding contact with the inner peripheral surface of the plate material, and a second squeegee state where the squeegee makes a sliding contact with an inner surface of the guide member.

The liquid supply apparatus is also characterized in that the squeegee is supported to be movable toward and away from the inner peripheral surface of the plate material, and squeegee moving means is provided for moving the squeegee between a plate material sliding-contact position where the squeegee makes a sliding contact with the inner peripheral surface of the plate material, and a guide member sliding-contact position where the squeegee makes a sliding contact with an inner surface of the guide member.

The liquid supply apparatus is also characterized in that the squeegee scarcely deforms between the plate material sliding-contact position and the guide member sliding-contact position in accordance with an action of the squeegee moving means.

The liquid supply apparatus is also characterized in that the plate material is a cylindrical printing plate.

The liquid supply apparatus is also characterized in that the plate material is a plate-shaped printing plate, and is bent in an arcuate shape, and the guide member is disposed between opposed end portions of the arcuately bent plate material.

The liquid supply apparatus is also characterized in that the plate material is a plate-shaped printing plate, and the guide member is equipped with plate holding means for holding the plate.

The liquid supply apparatus is also characterized in that the squeegee moving means is an actuator for moving the squeegee.

The liquid supply apparatus is also characterized in that the squeegee is supported by the actuator via a bell crank.

The liquid supply apparatus is also characterized in that the squeegee moving means comprises a cam supported rotatably, and a cam follower disposed on a side of the squeegee.

The liquid supply apparatus is also characterized in that the cam is supported on a side of the hollow cylinder.

The liquid supply apparatus is also characterized in that the cam is driven by squeegee-moving drive means.

The liquid supply apparatus is also characterized in that the impression cylinder is formed in a larger diameter than a cylinder diameter of a transport cylinder, and the sheet holding means is disposed within the notch portion of the impression cylinder so that the sheet holding means holding the sheet does not protrude from the outer peripheral surface of the impression cylinder.

The liquid supply apparatus is also characterized in that the sheet holding means comprises a gripper and a gripper pad for holding the sheet, and the gripper and the gripper pad are disposed within the notch portion of the impression cylinder such that a holding surface of the gripper and a holding surface of the gripper pad, which contact the sheet, are inclined to a lower position toward a leading end of the sheet, and so that the gripper and the gripper pad holding the sheet do not protrude from the outer peripheral surface of the impression cylinder.

### EFFECTS OF THE INVENTION

According to the liquid supply apparatus concerned with the present invention, a liquid can be supplied from a liquid supply cylinder to a sheet, held on an impression cylinder, satisfactorily at a low cost even when the impression cylinder is rotated at a high speed.

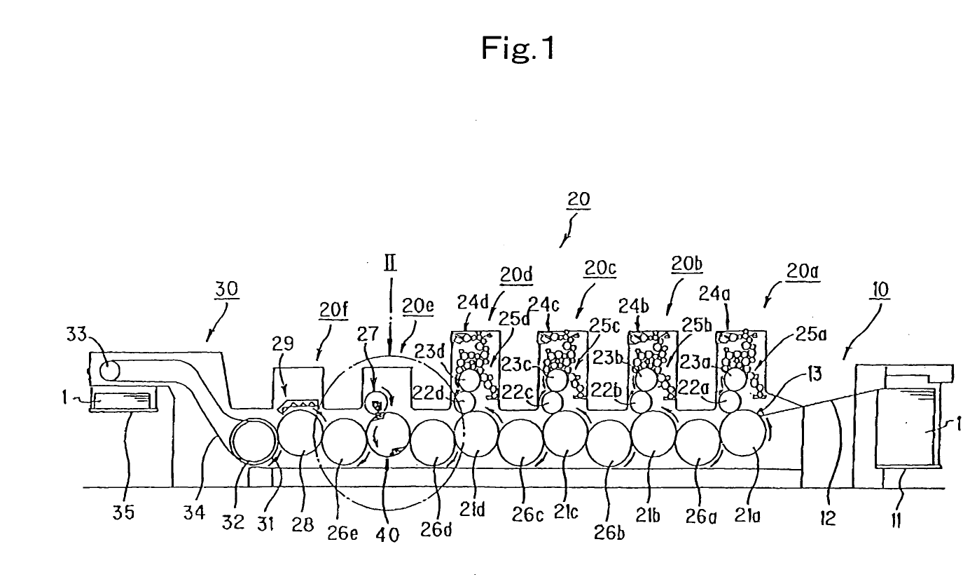

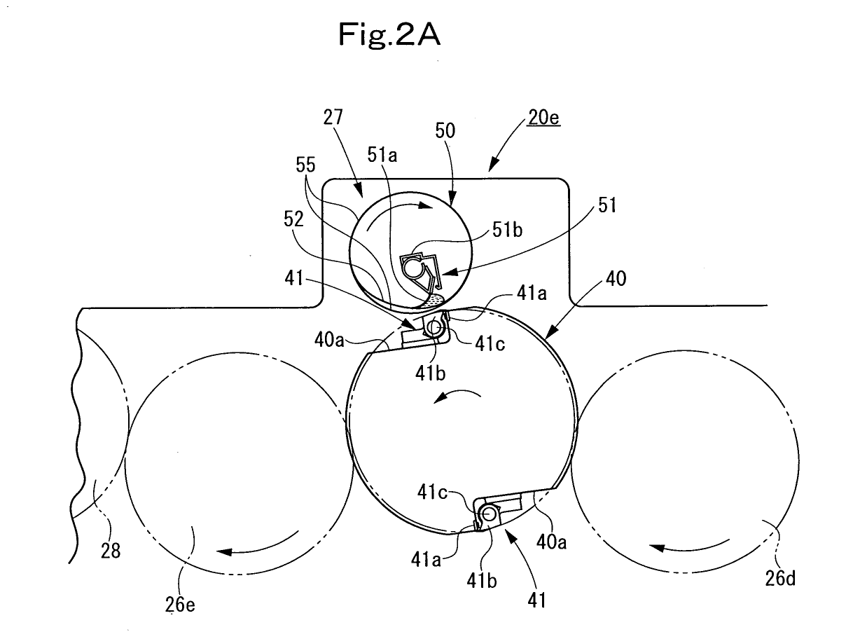

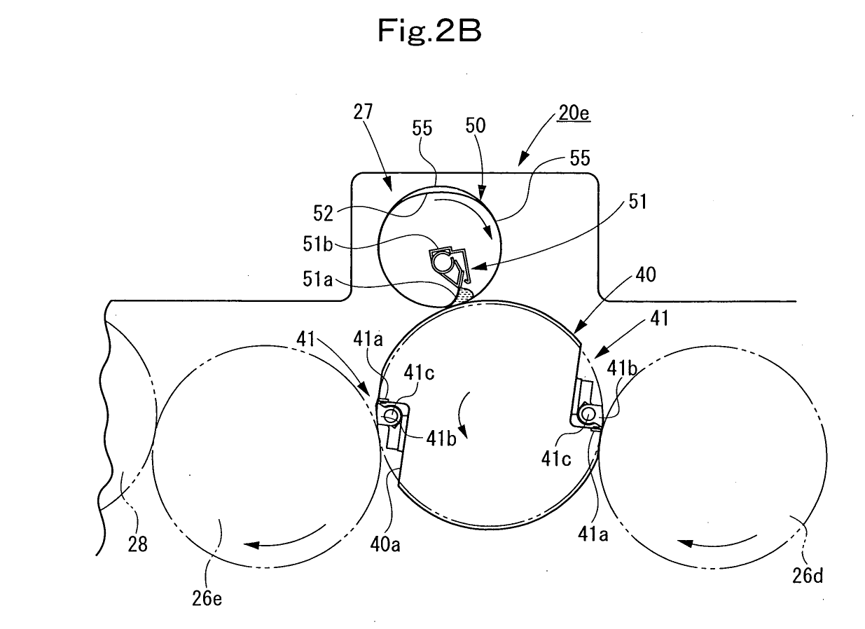

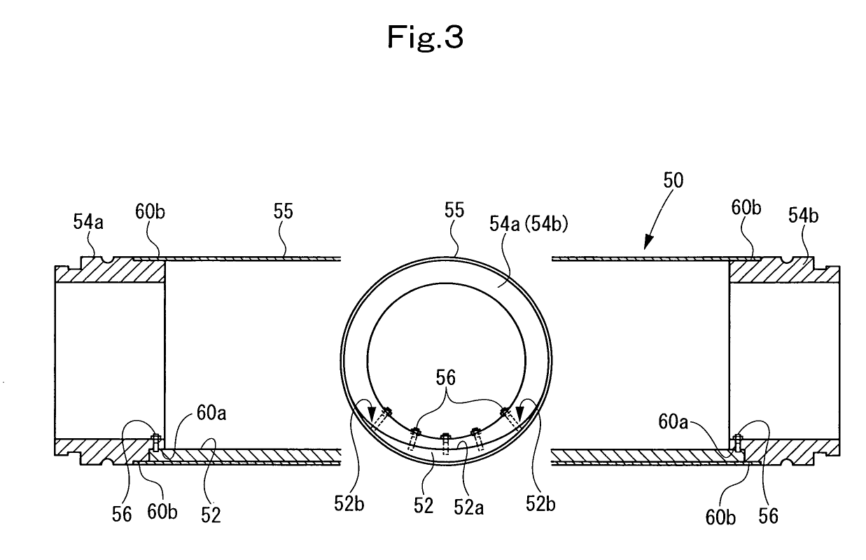

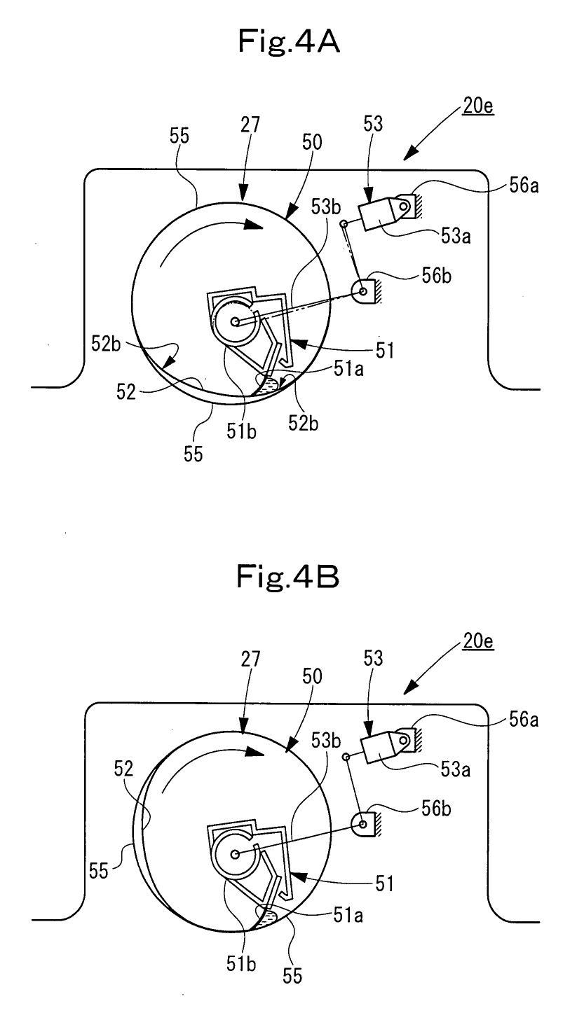

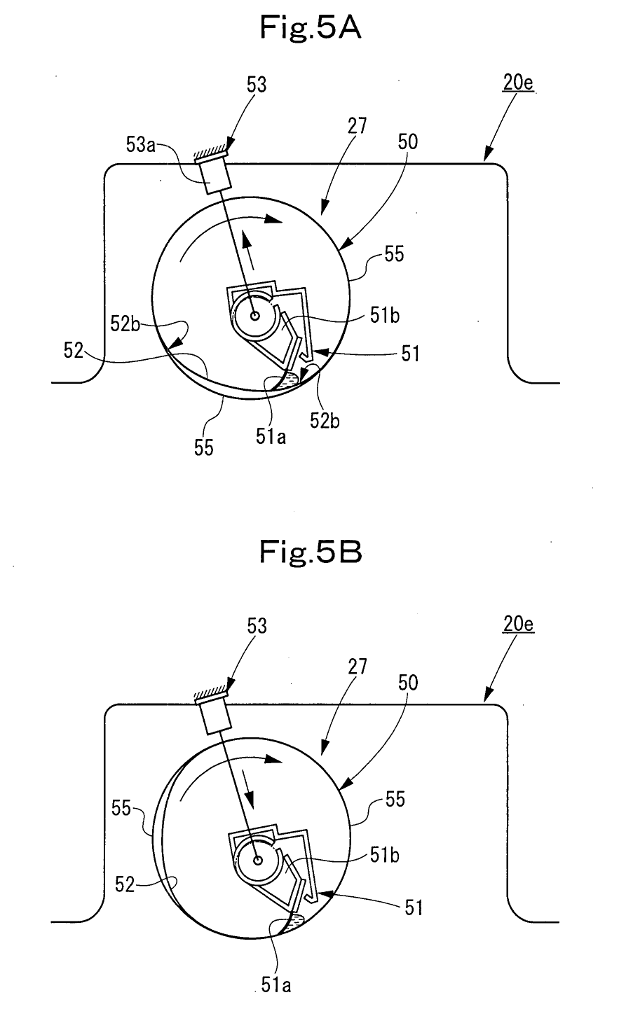

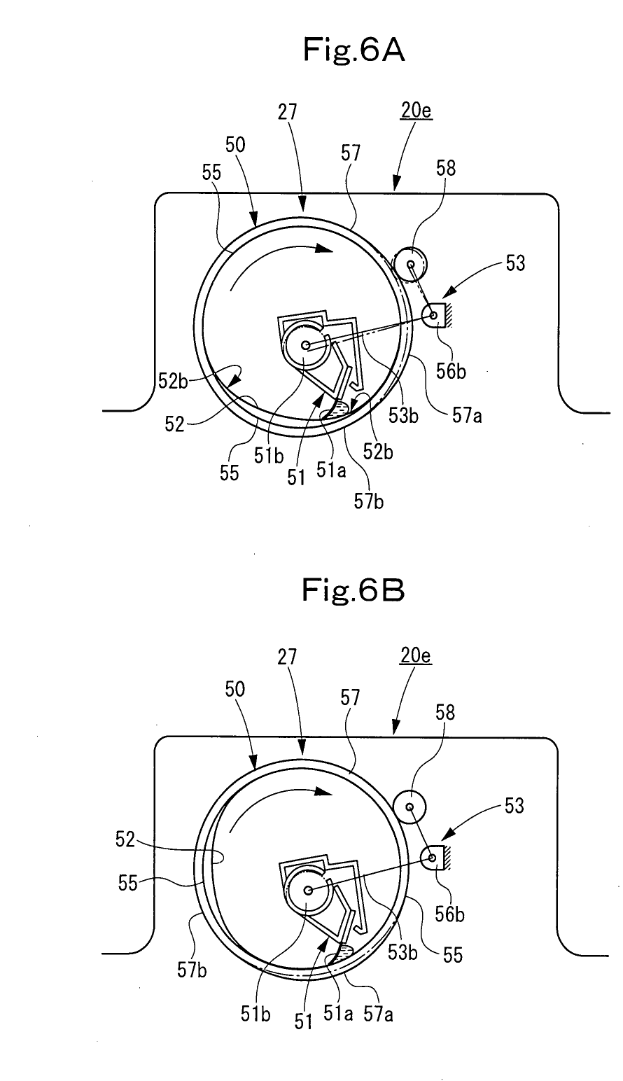

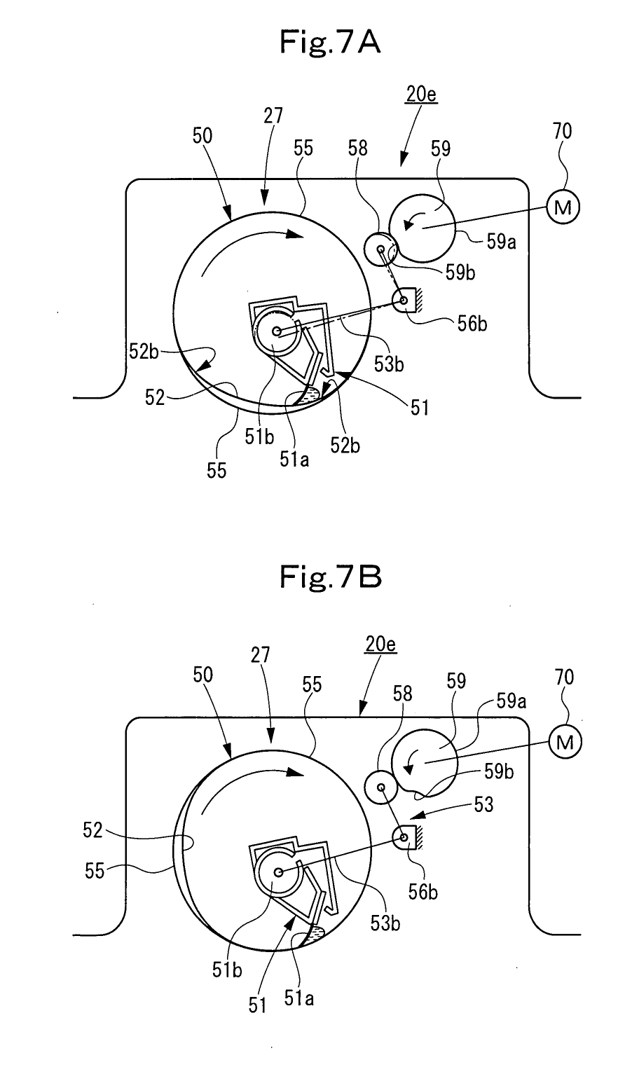

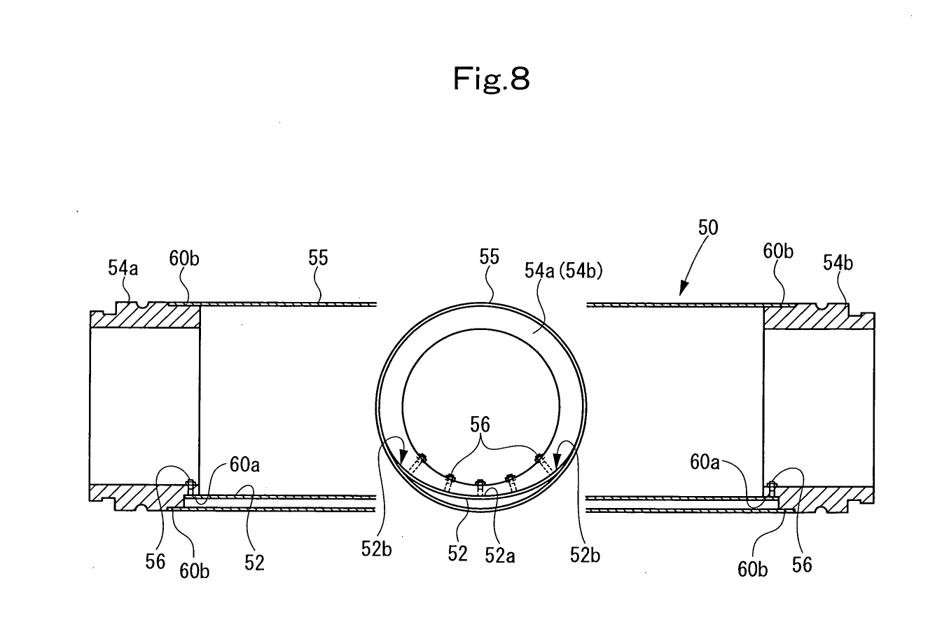

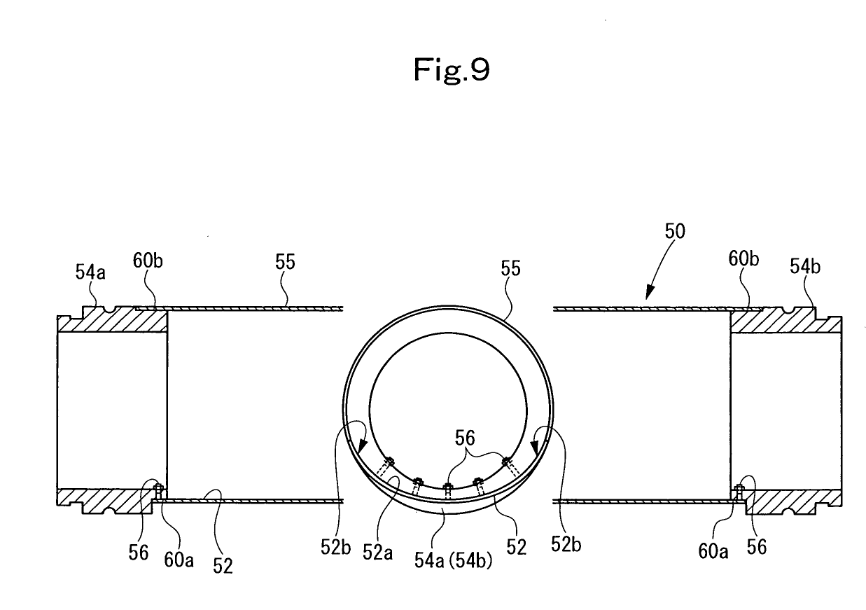

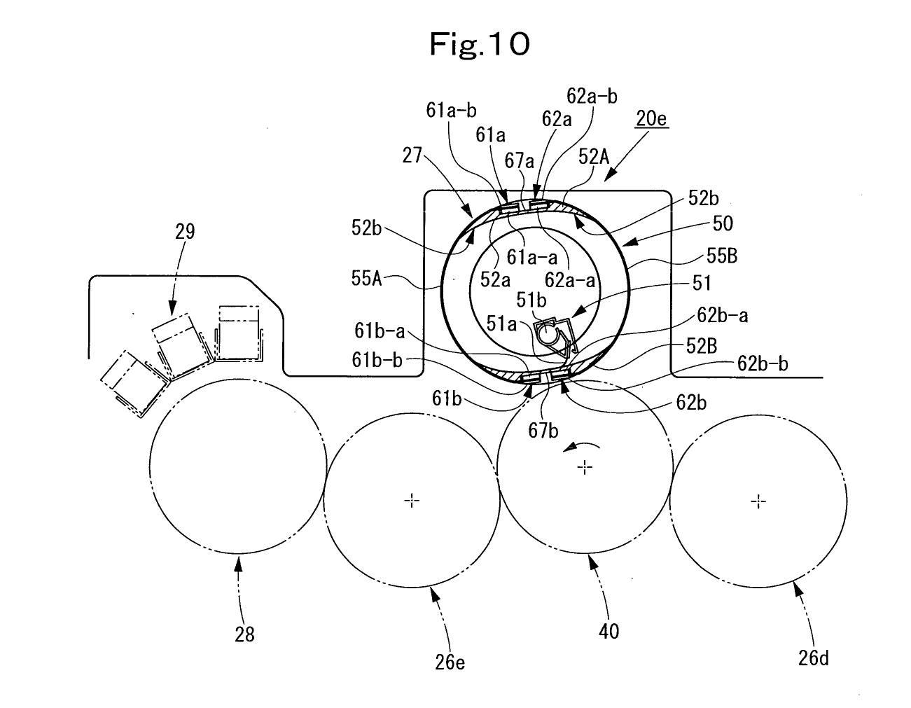

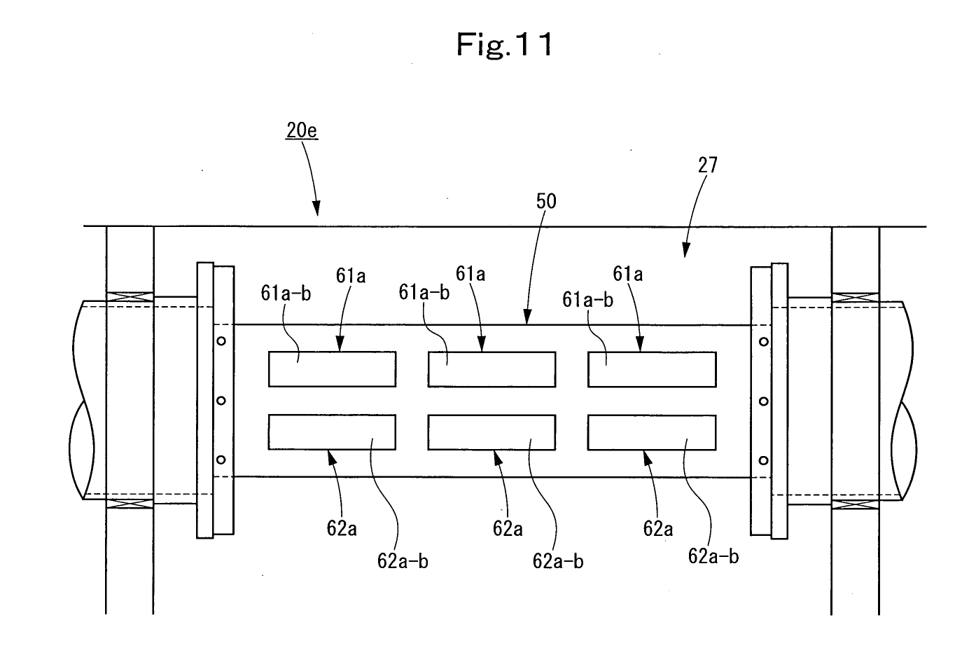

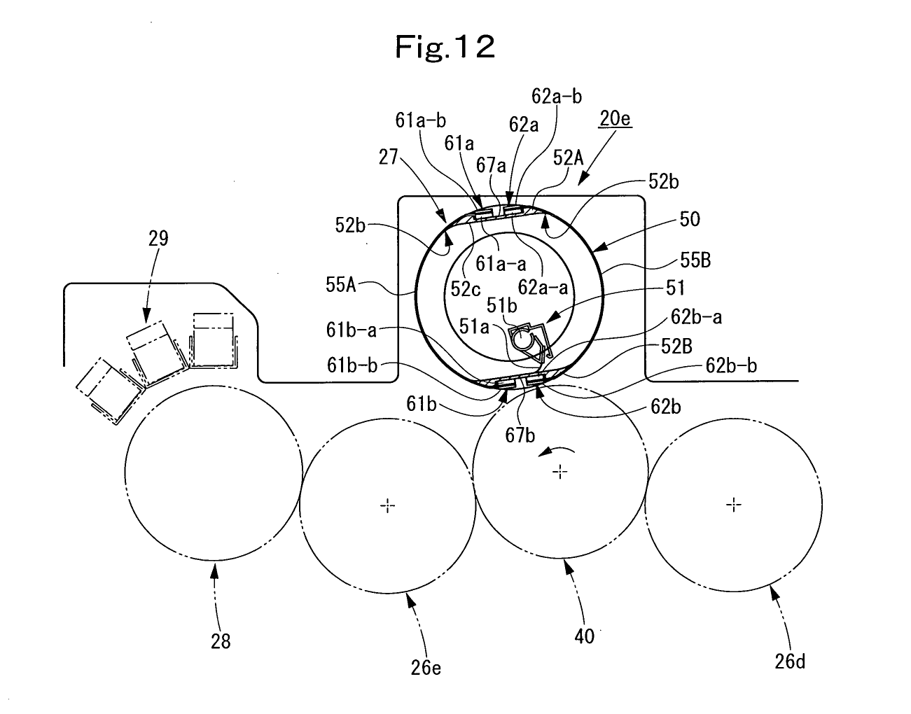

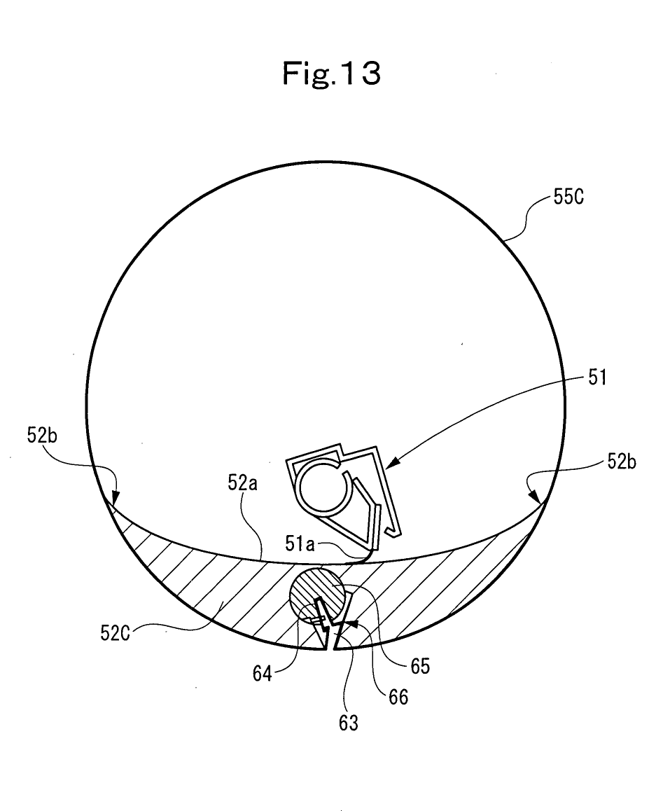

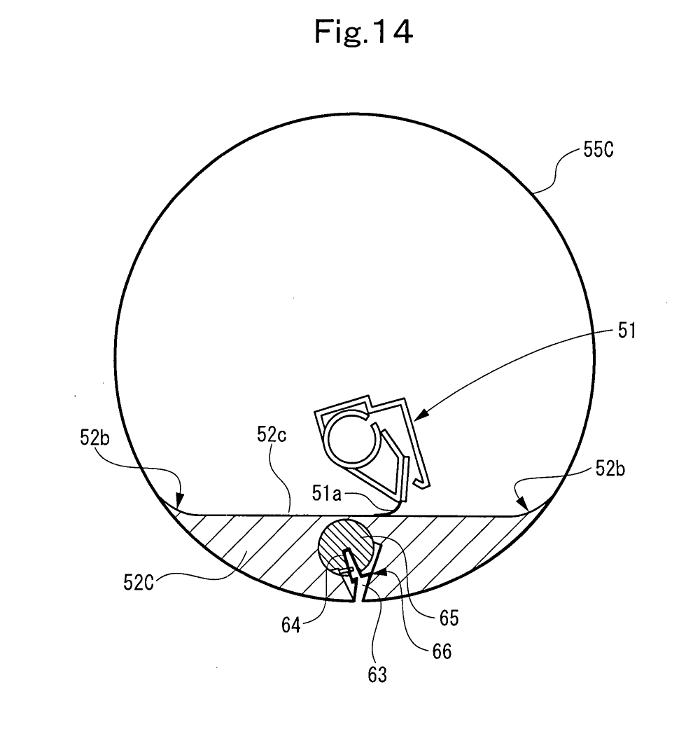

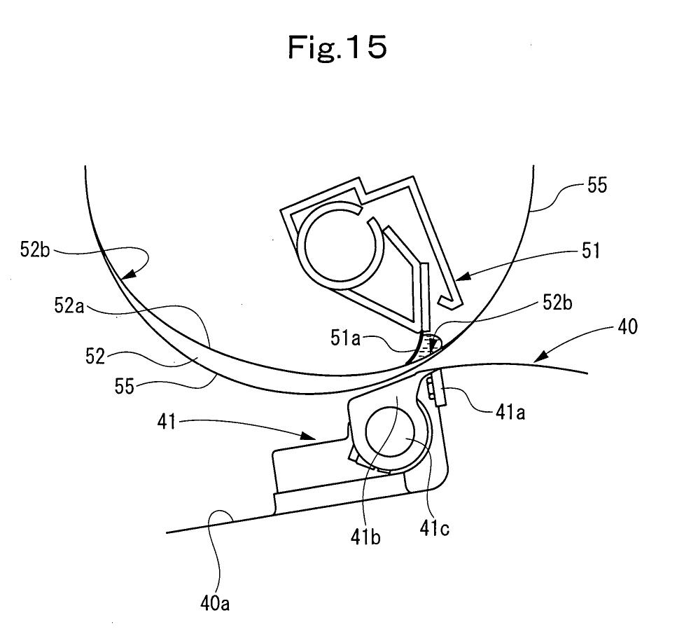

### BRIEF DESCRIPTION OF THE DRAWINGS

[FIG. 1] is a general schematic configurational drawing of a printing press showing Embodiment 1 of the present invention.

[FIG. 2A] is an enlarged view of a portion II in FIG. 1.

[FIG. 2B] is an enlarged view of the portion II in FIG. 1 in a different operating state.

[FIG. 3] is a structural explanation drawing of a hollow cylinder.

[FIG. 4A] is an explanation drawing of a squeegee moving means showing Embodiment 2 of the present invention.

[FIG. 4B] is an explanation drawing of the squeegee moving means in a different operating state.

[FIG. 5A] is an explanation drawing of a squeegee moving means showing Embodiment 3 of the present invention.

[FIG. 5B] is an explanation drawing of the squeegee moving means in a different operating state.

[FIG. 6A] is an explanation drawing of a squeegee moving means showing Embodiment 4 of the present invention.

[FIG. 6B] is an explanation drawing of the squeegee moving means in a different operating state.

[FIG. 7A] is an explanation drawing of a squeegee moving means showing Embodiment 5 of the present invention.

[FIG. 7B] is an explanation drawing of the squeegee moving means in a different operating state.

[FIG. 8] is a structural explanation drawing of a hollow cylinder showing Embodiment 6 of the present invention.

[FIG. 9] is a structural explanation drawing of a hollow cylinder showing Embodiment 7 of the present invention.

[FIG. 10] is a schematic configurational drawing of a screen printing unit showing Embodiment 8 of the present invention.

[FIG. 11] is a plan view of a rotary screen device.

[FIG. 12] is a schematic configurational drawing of a screen printing unit showing Embodiment 9 of the present invention.

[FIG. 13] is a sectional view of a hollow cylinder showing Embodiment 10 of the present invention.

[FIG. 14] is a sectional view of a hollow cylinder showing Embodiment 11 of the present invention.

[FIG. 15] is a structural explanation drawing of an impression cylinder in a rotary screen device showing Embodiment 12 of the present invention.

### DESCRIPTION OF THE REFERENCE NUMERALS

1 Sheet,
10 Feeder,
11 Feed pile board,
12 Feeder board,
13 Swing arm shaft pregripper,
20 Printing section,
20a to 20d First to fourth offset printing units,
20e Screen printing unit,
20f Drying unit,
21a to 21d Impression cylinders,
22a to 22d Blanket cylinders,
23a to 23d Plate cylinders,
24a to 24d Ink supply devices,
25a to 25d Dampeners,
26a to 26e Transfer cylinders,
27 Rotary screen device,
28 Transport cylinder,
29 Drying lamp,
30 Delivery unit,
31 Delivery drum,
32, 33 Sprockets,
34 Delivery chain,
35 Delivery pile board,
40 Impression cylinder,
40a Notch portion,
41 Gripper device,
41a Gripper pad,
41b Gripper,
41c Gripper shaft,
50 Hollow cylinder,
51 Squeegee,
51a Rubber plate,
51b Holder,
52, 52A, 52B, 52C Squeegee guides,
52a Curved surface,
52b Curved surface portion,
52c Flat surface,
53 Squeegee moving means,
53a Actuator,
53b Bell crank,
54a, 54b End members,
55, 55A, 55B, 55C Screens,
56 Bolt,
56a, 56b Brackets,
57 Cam,
57a High portion,
57b Low portion,
58 Cam follower,
59 Cam,
59a High portion,
59b Low portion, 60a, 60b Step portions,
61a, 61b Plate clamping rails,
61a-a, 61b-a Bottom clamping rails,
61a-b, 61b-b Gripper boards,
62a, 62b Plate clamping rails,
62a-a, 62b-a Bottom clamping rails,
62a-b, 62b-b, 63 Long grooves,
64 Retainer,
65 Winding rod,
66 Winding and tightening device,
67a, 67b Notches,
70 Motor.

### BEST MODE FOR CARRYING OUT THE INVENTION

The liquid supply apparatus according to the present invention will be described in detail by the following embodiments with reference to the accompanying drawings:

### Embodiment 1

FIG. 1 is a general schematic configurational drawing of a printing press showing Embodiment 1 of the present invention. FIG. 2A is an enlarged view of a portion II in FIG. 1. FIG. 2B is an enlarged view of the portion II in FIG. 1 in a different operating state. FIG. 3 is a structural explanation drawing of a hollow cylinder.

As shown in FIG. 1, a feed pile board 11 is provided in a feeder 10. The feeder 10 is provided with a feeder board 12 which feeds sheets 1 on the feed pile board 11, one by one, to a printing section 20. A swing arm shaft pregripper 13 for passing the sheet 1 on to an impression cylinder 21a of a first offset printing unit 20a of the printing section 20 is provided at the front end of the feeder board 12.

A blanket cylinder 22a is in contact with a side of the impression cylinder 21a of the first offset printing unit 20a which is located downstream of the swing arm shaft pregripper 13 in the rotating direction of the impression cylinder 21a. A plate cylinder 23a is in contact with a side of the blanket cylinder 22a which is located upstream of the impression cylinder 21a in the rotating direction of the blanket cylinder 22a. An ink supply device 24a is provided upstream of the blanket cylinder 22a in the rotating direction of the plate cylinder 23a. A dampener 25a is provided upstream of the ink supply device 24a in the rotating direction of the plate cylinder 23a.

A side of the impression cylinder 21a of the first offset printing unit 20a, which is located downstream of the blanket cylinder 22a in the rotating direction of the impression cylinder 21a, is in contact with an impression cylinder 21b of a second offset printing unit 20b via a transfer cylinder 26a. The second offset printing unit 20b is furnished with a blanket cylinder 22b, a plate cylinder 23b, an ink supply device 24b, and a dampener 25b, as is the first offset printing unit 20a.

A side of the impression cylinder 21b of the second offset printing unit 20b, which is located downstream of the blanket cylinder 22b in the rotating direction of the impression cylinder 21b, is in contact with an impression cylinder 21c of a third offset printing unit 20c via a transfer cylinder 26b. The third offset printing unit 20c is also furnished with a blanket cylinder 22c, a plate cylinder 23c, an ink supply device 24c, and a dampener 25c, as is each of the first and second offset printing units 20a and 20b.

A side of the impression cylinder 21c of the third offset printing unit 20c, which is located downstream of the blanket cylinder 22c in the rotating direction of the impression cylinder 21c, is in contact with an impression cylinder 21d of a fourth offset printing unit 20d via a transfer cylinder 26c. The fourth offset printing unit 20d is also furnished with a blanket cylinder 22d, a plate cylinder 23d, an ink supply device 24d, and a dampener 25d, as is each of the first to third offset printing units 20a to 20c.

As shown in FIGS. 2A and 2B as well, an impression cylinder 40 of a screen printing unit 20e makes contact, via a transfer cylinder 26d, with a side of the impression cylinder 21d of the fourth offset printing unit 20d which is located downstream of the blanket cylinder 22d in the rotating direction of the impression cylinder 21d. The impression cylinder 40 has a structure as described below.

On the outer peripheral surface of the impression cylinder 40, a plurality of (two in the illustrated example) notch portions 40a, extending along the axial direction of the impression cylinder 40, are formed with equal spacing along the circumferential direction of the impression cylinder 40. A gripper device (sheet holding means) 41, which has a gripper pad 41a, a gripper 41b, and a gripper shaft 41c and can hold the sheet 1, is accommodated within the notch portion 40a.

In the present embodiment, the impression cylinder 40 is formed in a slightly larger cylinder diameter than the cylinder diameter of transfer cylinders (transport cylinders) 26d and 26e which comprise skeleton cylinders and contact the impression cylinder 40 in opposed relationship with each other, with the impression cylinder 40 being sandwiched therebetween. Thus, the gripper pad 41a and the gripper 41b of the above-mentioned gripper device 41 are arranged not to protrude from the outer peripheral surface of the impression cylinder 40 (namely, the gripper pad 41a and the gripper 41b are accommodated within the cylinder diameter) when they hold the sheet.

A rotary screen device 27 is disposed downstream of the transfer cylinder 26d in the rotating direction of the impression cylinder 40 of the screen printing unit 20e. The rotary screen device 27 is furnished with a hollow cylinder 50, a squeegee 51, and a squeegee guide (guide member) 52, as shown in FIG. 3 as well.

The hollow cylinder 50 comprises a cylindrical thin screen (plate material comprising stainless steel or nickel) 55 supported between a pair of (i.e., right and left) end members (flanges) 54a and 54b rotatably supported by a machine frame, the screen 55 having small holes (not shown) corresponding to patterns etched in a circumferential portion thereof (see FIG. 3).

The squeegee 51 comprises a holder 51b positioned and immovably supported within the hollow cylinder 50, and a rubber plate 51a supported by the holder 51b. The front end of the rubber plate 51a is in a sliding contact with the inner peripheral surface of the screen 55 to supply special ink or the like (liquid), which has been stored inside the screen 55, to the sheet 1 held by the aforementioned gripper device 41 via the small holes of the screen 55 (see FIG. 2B).

The rubber plate 51a of the squeegee 51 elastically deforms between a first squeegee state (state of FIG. 2B), where the rubber plate 51a makes a sliding contact with the inner peripheral surface of the screen 55, and a second squeegee state (state of FIG. 2A), where the rubber plate 51a makes a sliding contact with the inner surface of the squeegee guide 52.

The squeegee guide 52 is formed of a crescent rigid body which is located inside the screen 55, and installed between the right and left paired end members 54a and 54b, so as to be opposed to the notch portion 40a of the impression cylinder 40, and which has an arcuate inner surface located inwardly of the inner peripheral surface of the screen 55.

That is, end portions in the longitudinal direction of the squeegee guide 52 are bound by a plurality of bolts 56 to arcuate stepped portions (guide member support portions) 60a formed at the inner end portions of the end members 54a and 54b. End portions in the longitudinal direction of the screen 55 are fitted to perfect-circle-shaped stepped portions (plate material support portions) 60b formed at the outer periphery of inner end portions of the end members 54a and 54b (see FIG. 3).

The squeegee guide 52 has a continuous curved surface 52a having a larger radius of curvature than the radius of curvature of the inner peripheral surface of the screen 55. Curved surface portions 52b at opposite end portions of the squeegee guide 52 communicate with the inner peripheral surface of the screen 55 smoothly and continuously without a step (see FIG. 3).

The aforementioned transfer cylinder 26e is in contact with a side of the impression cylinder 40 of the screen printing unit 20e which is located downstream of the rotary screen device 27 in the rotating direction of the impression cylinder 40. A transport cylinder 28 of a drying unit 20f is in contact with a side of the transfer cylinder 26e which is located downstream of the impression cylinder 40 in the rotating direction of the transfer cylinder 26e. A drying lamp 29 for throwing ultraviolet radiation (UV) is disposed downstream of the transfer cylinder 26e in the rotating direction of the transport cylinder 28.

A delivery drum 31 of a delivery unit 30 is in contact with a side of the transport cylinder 28 of the drying unit 20f which is located downstream of the drying lamp 29 in the rotating direction of the transport cylinder 28. In the delivery drum 31, a sprocket 32 is provided coaxially to be rotatable integrally. A delivery pile board 35 is provided in the delivery unit 30. A sprocket 33 is provided above the delivery pile board 35. A delivery chain 34, which has a plurality of delivery grippers (not shown) attached thereto with predetermined spacing, is looped between the sprockets 32 and 33.

The actions of the printing press according to the present embodiment, which has been configured as above, will be described.

The sheets 1 are fed, one by one, from the feed pile board 11 onto the feeder board 12 in the feeder 10. The sheet 1 is passed by the swing arm shaft pregripper 13 on to the impression cylinder 21a of the first offset printing unit 20a in the printing section 20. Separately, ink and dampening water are supplied from the ink supply device 24a and the dampener 25a of the first offset printing unit 20a to the plate cylinder 23a, and then supplied from the plate cylinder 23a to the blanket cylinder 22a. Ink is transferred from the blanket cylinder 22a to the sheet 1, so that the sheet 1 is printed in a first color. Then, the sheet 1 is passed via the transfer cylinder 26a on to the impression cylinder 21b of the second offset printing unit 20b, and is printed in a second color in the second offset printing unit 20b as in the first offset printing unit 20a. Subsequently, the sheet 1 is printed similarly in a third color and a fourth color in the third and fourth offset printing units 20c and 20d. Then, the sheet 1 is subjected to gripping change by the gripper pad 41a and the gripper 41b of the impression cylinder 40 of the screen printing unit 20e via the transfer cylinder 26d. Then, the sheet 1 is printed in a thick layer of special ink or the like by the rotary screen device 27 of the screen printing unit 20e, as described earlier (see the first squeegee state of FIG. 2B).

The impression cylinder 40 is formed in a slightly larger cylinder diameter than the cylinder diameter of the transfer cylinders 26d and 26e contacting the impression cylinder 40 in opposed relationship with each other, with the impression cylinder 40 being sandwiched therebetween. As a result, the gripper pad 41a and the gripper 41b in the gripper device 41 of the impression cylinder 40 holding the sheet are arranged not to protrude from the outer peripheral surface of the impression cylinder 40 (namely, the gripper pad 41a and the gripper 41b are accommodated within the cylinder diameter). Thus, the gripper pad 41a and the gripper 41b are kept from interfering with the screen 55 in the hollow cylinder 50 of the rotary screen device 27, and damage to the screen 55 is prevented.

In addition, when the notch portion 40a of the impression cylinder 40 is opposed to the screen 55 where the squeegee guide 52 is located, the second squeegee state of FIG. 2A is achieved. In this state, the rubber plate 51a is deflected by elastic deformation, and its front end shifts from the inner peripheral surface of the screen 55 to the inner surface of the squeegee guide 52 while making a sliding contact with these surfaces.

Consequently, the screen 55 is kept from sagging into the notch portion 40a of the impression cylinder 40 upon urging by the front end of the rubber plate 51a, so that the screen 55 is prevented from contacting the gripper 41b, etc. of the gripper device 41 within the notch portion 40a to undergo damage.

In the present embodiment, the curved surface portions 52b at the opposite end portions of the squeegee guide 52 communicate with the inner peripheral surface of the screen 55 smoothly and continuously without any step. Thus, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like.

The sheet 1, which has thus been printed in a thick layer of special ink or the like by the rotary screen device 27, is passed from the impression cylinder 40 on to the transport cylinder 28 of the drying unit 20f via the transfer cylinder 26e to have the printed special ink or the like dried by UV from the drying lamp 29. Then, the sheet 1 is passed on to the delivery drum 31 of the delivery unit 30, from which the sheet 1 is transported by the delivery chain 34 for delivery onto the delivery pile board 35.

In the present embodiment, as described above, even during high speed printing, no vibrations are caused to the impression cylinder 40 of the screen printing unit 20e. Moreover, a collision between the gripper pad 41a/gripper 41b and the screen 55, and sagging of the screen 55 into the notch portion 41a can be prevented by a simple structure involving the installation of the squeegee guide 52.

Hence, satisfactory application, by printing, of special ink or the like from the rotary screen 27 onto the sheet 1 held by the impression cylinder 40 can be performed at a low cost even at a high speed.

### Embodiment 2

FIG. 4A is an explanation drawing of a squeegee moving means showing Embodiment 2 of the present invention. FIG. 4B is an explanation drawing of the squeegee moving means in a different operating state.

The present embodiment is an embodiment in which the holder 51b of the squeegee 51 in Embodiment 1 is movably supported in a direction in which the holder 51b is moved toward and away from the inner peripheral surface of the screen 55 (namely, in an up-and-down direction in the drawings). In this embodiment, the holder 51b is moved by a squeegee moving means 53 to be described later, whereby the rubber plate 51a of the squeegee 51 is moved between a screen sliding-contact position (plate material sliding-contact position: see FIG. 4B) where the rubber plate 51a makes a sliding contact with the inner peripheral surface of the screen 55, and a squeegee guide sliding-contact position (guide member sliding-contact position: see FIG. 4A) where the rubber plate 51a makes a sliding contact with the inner surface of the squeegee guide 52. Thus, the rubber plate 51a of the squeegee 51 scarcely deforms between the plate material sliding-contact position and the guide member sliding-contact position, unlike Embodiment 1.

The squeegee moving means 53 comprises an actuator 53a, such as an air cylinder, having a head portion proximal end supported on the machine frame by a pin via a bracket 56a; and a bell crank 53b having an end portion pinned to the front end of the piston rod of the actuator 53a, an intermediate bending portion pinned to the machine frame via a bracket 56b, and the other end portion pinned to the holder 51b of the squeegee 51.

The actuator 53a is driven and controlled by a control device (not shown) in accordance with the rotations of the hollow cylinder 50 and the impression cylinder 40 to bring the whole of the squeegee 51 upward at a time when the squeegee guide 52 corresponds with the notch portion 40a of the impression cylinder.

That is, the actuator 53a works to the contraction side, whereby the bell crank 53b sways clockwise to bring the squeegee 51 upward as a whole. As a result, the front end of the rubber plate 51a shifts from the inner peripheral surface of the screen 55 to the inner periphery of the squeegee guide 52 while making a sliding contact (see the state of FIG. 4A). Conversely, when the squeegee guide 52 passes from this state, the actuator 53a works to the expansion side, whereby the bell crank 53b sways counterclockwise to bring the squeegee 51 downward as a whole. As a result, the front end of the rubber plate 51a shifts from the inner surface of the squeegee guide 52 to the inner peripheral surface of the screen 55 while making a sliding contact.

According to the above features, when the notch portion 40a of the impression cylinder 40 opposes the screen 55 where the squeegee guide 52 is situated, the front end of the rubber plate 51a shifts from the inner peripheral surface of the screen 55 to the inner surface of the squeegee guide 52 while making a sliding contact, as in Embodiment 1. Thus, the same actions and effects as those in Embodiment 1 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a undergoes no repeated load by the squeegee moving means 53 and scarcely deforms between the plate cylinder sliding-contact position and the guide member sliding-contact position. This affords the advantage that the durability of the rubber plate 51a is improved.

### Embodiment 3

FIG. 5A is an explanation drawing of a squeegee moving means showing Embodiment 3 of the present invention. FIG. 5B is an explanation drawing of the squeegee moving means in a different operating state.

This is an embodiment in which the squeegee moving means 53 in Embodiment 2 is composed only of the actuator 53a, such as an air cylinder, secured to the machine frame side.

According to this embodiment, the expansion and contraction of the actuator 53a enable the rubber plate 51a of the squeegee 51 to be reciprocated in the vertical direction via the holder 51b of the squeegee 51 pinned to the front end of the piston rod of the actuator 53a. Thus, the same actions and effects as those in Embodiment 2 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like.

### Embodiment 4

FIG. 6A is an explanation drawing of a squeegee moving means showing Embodiment 4 of the present invention. FIG. 6B is an explanation drawing of the squeegee moving means in a different operating state.

The present embodiment is an embodiment in which the squeegee moving means 53 in Embodiment 2 is composed of a cam 57 fixed to a hollow cylinder 50, rotating integrally with the hollow cylinder 50, and having a high portion 57a and a low portion 57b; a cam follower 58 following the cam 57; and a bell crank 53b which has one end portion pinned to a rotation center portion of the cam follower 58, an intermediate bending portion pinned to the machine frame via a bracket 56b, and the other end portion pinned to a holder 51b of a squeegee 51.

According to this embodiment, the whole of the rubber plate 51a of the squeegee 51 is reciprocated in the vertical direction by the high portion 57a and the low portion 57b of the cam 57 via the bell crank 53b automatically at a required time, namely, without need for control by a control device. As a result, the same actions and effects as those in Embodiment 2 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the cam 57 is fixed to the hollow cylinder 50. Thus, the advantages are obtained that the cam 57 can be rotated simply by a motor for rotating the printing press, and there is no need to provide a dedicated motor for rotating the cam 57.

### Embodiment 5

FIG. 7A is an explanation drawing of a squeegee moving means showing Embodiment 5 of the present invention. FIG. 7B is an explanation drawing of the squeegee moving means in a different operating state.

The present embodiment is an embodiment in which the cam mechanism in Embodiment 4 is modified such that the cam follower 58 is caused to follow a high portion 59a and a low portion 59b of a cam 59 driven by a motor 70 (squeegee moving drive means), the cam 59 being provided instead of the cam 57 coaxial with the hollow cylinder 50. According to this embodiment, the same actions and effects as those in Embodiment 4 are exhibited.

### Embodiment 6

FIG. 8 is a structural explanation drawing of an impression cylinder showing Embodiment 6 of the present invention.

The present embodiment is an embodiment in which the squeegee guide 52 in Embodiment 1 is a plate-shaped or membrane-shaped material instead of a crescent rigid body, and is formed from the same material as that for the screen 55, or from an elastic body or a film. In the present embodiment, the same actions and effects as those in Embodiment 1 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a may be one which elastically deforms as in Embodiment 1, or which practically does not elastically deform as in Embodiment 2.

### Embodiment 7

FIG. 9 is a structural explanation drawing of the hollow cylinder showing Embodiment 7 of the present invention.

The present embodiment is an embodiment in which a plate-shaped member is used as the screen 55 in Embodiment 1, the plate-shaped member is bent in an arcuate form, and a plate- or film-shaped squeegee guide 52 is provided to connect the opposed ends of the arcuate screen 55. According to this embodiment, the same actions and effects as those in Embodiment 1 are obtained. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. Alternatively, the squeegee guide 52 comprising a crescent rigid body may be used to connect the opposed ends of the arcuate screen 55, as in Embodiment 1. In the present embodiment, moreover, the rubber plate 51a may be one which elastically deforms as in Embodiment 1, or which practically does not elastically deform as in Embodiment 2.

### Embodiment 8

FIG. 10 is a schematic configurational drawing of a screen printing unit showing Embodiment 8 of the present invention. FIG. 11 is a plan view of a rotary screen device.

The present embodiment is an embodiment in which the cylinder diameter of the hollow cylinder 50 in Embodiment 1 is the same as the cylinder diameter of the impression cylinder 40; squeegee guides 52A and 52B formed from crescent rigid bodies are provided at two locations in point symmetry; plate clamps (plate holding means) 61a, 61b, 62a, 62b are provided within notches 67a, 67b of these squeegee guides 52A, 52B; and two plate-shaped screens 55A and 55B each having a length nearly half the circumference of the hollow cylinder 50 are bent in an arcuate form and held between the plate clamps 61a-61b and 62a-62b symmetrical between the squeegee guides 52A and 52B.

The plate clamps 61a, 61b, 62a and 62b comprise bottom clamping rails 61a-a, 61b-a, 62a-a and 62b-a positioned within the notches 67a and 67b and extending in the cylinder shaft direction; gripper boards 61a-b, 61b-b, 62a-b and 62b-b pivoted swingably by the bottom clamping rails 61a-a, 61b-a, 62a-a and 62b-a and extending in the cylinder shaft direction; and gripping cams (not shown) which engage the gripper boards 61a-b, 61b-b, 62a-b and 62b-b, are journaled on a pivot shaft (not shown), and swing the gripper boards 61a-b, 61b-b, 62a-b and 62b-b in the direction of gripping, of the screens 55A, 55B in accordance with the pivoting action of the pivot shaft. Three each of the plate clamps 61a, 61b, 62a and 62b are provided in the cylinder shaft direction (see FIG. 11).

According to this embodiment, when the notch portion 40a of the impression cylinder 40 opposes the screen 55A or 55B where the squeegee guide 52A or 52B is located, the front end of the rubber plate 51a shifts from the inner surface of the screen 55A or 55B to the inner surface of the squeegee guide 52A or 52B while making a sliding contact, as in Embodiment 1. Thus, the same actions and effects as those in Embodiment 1 are exhibited. In the present embodiment as well, the curved surface portions 52b at the opposite end portions of the squeegee guide 52A or 52B communicate with the inner surface of the screen 55A or 55B smoothly and continuously without any step. In the present embodiment, therefore, when the rubber plate 51a shifts from the inner surface of the screen 55A or 55B to the inner surface of the squeegee guide 52A or 52B, or from the inner surface of the squeegee guide 52A or 52B to the inner surface of the screen 55A or 55B, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the two screens 55A and 55B can be mounted, so that the durability of the screen is increased as compared with that of the single screen. In the present embodiment, the rubber plate 51a may be one which elastically deforms as in Embodiment 1, or which practically does not elastically deform as in Embodiment 2.

### Embodiment 9

FIG. 12 is a schematic configurational drawing of a screen printing unit showing Embodiment 9 of the present invention.

The present embodiment is an embodiment in which the shape of the inner surface between the pair of curved surface portions 52b and 52b of the squeegee guides 52A, 52B in Embodiment 9 is changed from the curved surface 52a to a flat surface 52c. According to this embodiment, the same actions and effects as those in Embodiment 9 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a may be one which elastically deforms as in Embodiment 1, or which practically does not elastically deform as in Embodiment 2.

### Embodiment 10

FIG. 13 is a sectional view of a hollow cylinder showing Embodiment 10 of the present invention.

The present embodiment is an embodiment in which the squeegee guide 52C formed from a crescent rigid body in Embodiment 1 is provided with a long groove 63, and a winding and tightening device (plate holding means) 66 provided in the long groove 63 bends a plate-shaped screen 55C of a length corresponding to nearly the circumference of the hollow cylinder 50 in an arcuate form and holds opposite end portions of the screen 55C.

The winding and tightening device 66 comprises a winding rod 65 turnably fitted into the long groove 63, and a retainer 64 made of a leaf spring which is inserted into a kerf formed in the winding rod 65 to hold the opposite end portions of the screen 55C. The winding and tightening device 66 is the same one as used in a plate mounting structure of a rotary printing press.

According to this embodiment, when the notch portion 40a of the impression cylinder 40 opposes the screen 55C where the squeegee guide 52C is located, the front end of the rubber plate 51a shifts from the inner peripheral surface of the screen 55C to the inner surface of the squeegee guide 52C via the curved surface portion 52b while making a sliding contact. Thus, the same actions and effects as those in Embodiment 1 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a may be one which elastically deforms as in Embodiment 1, or which practically does not elastically deform as in Embodiment 2.

### Embodiment 11

FIG. 14 is a sectional view of a hollow cylinder showing Embodiment 11 of the present invention.

The present embodiment is an embodiment in which the shape of the inner surface between the pair of curved surface portions 52b and 52b of the squeegee guide 52C in Embodiment 11 is changed from the curved surface 52a to a flat surface 52c. According to this embodiment, the same actions and effects as those in Embodiment 11 are exhibited. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a may be one which elastically deforms as in Embodiment 1, or which practically does not elastically deform as in Embodiment 2.

### Embodiment 12

FIG. 15 is a structural explanation drawing of an impression cylinder in a rotary screen device showing Embodiment 12 of the present invention.

The present embodiment is an embodiment in which the impression cylinder 40 in Embodiments 1 to 11 is formed in a diameter equal to the cylinder diameter of the transfer cylinders 26d and 26e which contact the impression cylinder 40 in opposed relationship with each other, with the impression cylinder 40 being sandwiched therebetween, instead of being formed in a slightly larger diameter than the cylinder diameter of the transfer cylinders 26d and 26e; and the shape of the holding surfaces, for the sheet 1, of the gripper pad 41a and the gripper 41b in the gripper device 41 of the impression cylinder 40 are changed such that these holding surfaces do not protrude from the outer peripheral surface of the impression cylinder 40 (namely, they are accommodated within the cylinder diameter) when they hold the sheet 1. In the illustrated embodiment, the holding surface of the gripper pad 41a and the holding surface of the gripper 41b form inclined surfaces which are inclined to a lower position toward the leading end of the sheet 1.

According to this embodiment, the gripper pad 41a and the gripper 41b are kept from interfering with the screen 55 in the hollow cylinder 50 of the rotary screen device 27, and damage to the screen 55 is prevented. Thus, the same actions and effects as those in Embodiment 1 are obtained. In the present embodiment as well, the curved surface portions 52b at the opposite end portions of the squeegee guide 52 communicate with the inner peripheral surface of the screen 55 smoothly and continuously without any step. In the present embodiment, therefore, when the rubber plate 51a shifts from the inner peripheral surface of the screen 55 to the inner surface of the squeegee guide 52, or from the inner surface of the squeegee guide 52 to the inner peripheral surface of the screen 55, behaviors of the front end portion of the rubber plate 51a are prevented (namely, the rubber plate 51a is in constant contact with one of the inner peripheral surface of the screen 55 and the inner surface of the squeegee guide 52). Consequently, the front end portion of the rubber plate 51a smoothly shifts, avoiding leakage of special ink or the like. In the present embodiment, moreover, the rubber plate 51a may be one which elastically deforms as in Embodiment 1, or which practically does not elastically deform as in Embodiment 2.

### INDUSTRIAL APPLICABILITY

The present invention can be applied not only to a case where a rotary screen device is used for printing a sheet with special ink or the like in a thick layer, but also to a case, for example, where a liquid is supplied from a liquid supply cylinder to a sheet held on an impression cylinder, such as a case where a rotary screen device is used for coating a sheet with varnish or the like.

1. A liquid supply apparatus, comprising:
an impression cylinder supported rotatably and having a notch portion formed in an outer peripheral surface thereof;
sheet holding means disposed within the notch portion of the impression cylinder for holding a sheet; and
a rotary screen device including a hollow cylinder which is supported rotatably and which supports a plate material having holes formed in a circumferential portion of the plate material, and a squeegee which is located within the hollow cylinder, and which makes a sliding contact with an inner peripheral surface of the plate material for supplying a liquid stored inside the plate material to the sheet held by the sheet holding means through the holes of the plate material,
the rotary screen device further including a guide member which is supported in the hollow cylinder such that curved surface portions formed at least at opposite end portions of the guide member communicate with the inner peripheral surface of the plate material.

2. The liquid supply apparatus according to claim 1, wherein the guide member has a continuous curved surface having a larger radius of curvature than a radius of curvature of the inner peripheral surface of the plate material.

3. The liquid supply apparatus according to claim 1, wherein the hollow cylinder is equipped with a plate material support portion for supporting the plate material, and a guide member support portion for supporting the guide member.

4. The liquid supply apparatus according to claim 1, wherein the guide member is formed from a crescent rigid body.

5. The liquid supply apparatus according to claim 1, wherein the guide member has a continuous curved surface between a pair of the curved surface portions of the guide member.

6. The liquid supply apparatus according to claim 1, wherein the squeegee elastically deforms between a first squeegee state where the squeegee makes a sliding contact with the inner peripheral surface of the plate material, and a second squeegee state where the squeegee makes a sliding contact with an inner surface of the guide member.

7. The liquid supply apparatus according to claim 1, wherein
the squeegee is supported to be movable toward and away from the inner peripheral surface of the plate material, and
squeegee moving means is provided for moving the squeegee between a plate material sliding-contact position where the squeegee makes a sliding contact with the inner peripheral surface of the plate material, and a guide member sliding-contact position where the squeegee makes a sliding contact with an inner surface of the guide member.

8. The liquid supply apparatus according to claim 7, wherein the squeegee scarcely deforms between the plate material sliding-contact position and the guide member sliding-contact position in accordance with an action of the squeegee moving means.

9. The liquid supply apparatus according to claim 1, wherein the plate material is a cylindrical printing plate.

10. The liquid supply apparatus according to claim 1, wherein
the plate material is a plate-shaped printing plate, and is bent in an arcuate shape, and
the guide member is disposed between opposed end portions of the arcuately bent plate material.

11. The liquid supply apparatus according to claim 1, wherein
the plate material is a plate-shaped printing plate, and
the guide member is equipped with plate holding means for holding the plate.

12. The liquid supply apparatus according to claim 7, wherein the squeegee moving means is an actuator for moving the squeegee.

13. The liquid supply apparatus according to claim 12, wherein the squeegee is supported by the actuator via a bell crank.

14. The liquid supply apparatus according to claim 12, wherein the squeegee moving means comprises a cam supported rotatably, and a cam follower disposed on a side of the squeegee.

15. The liquid supply apparatus according to claim 14, wherein the cam is supported on a side of the hollow cylinder.

16. The liquid supply apparatus according to claim 14, wherein the cam is driven by squeegee moving drive means.

17. The liquid supply apparatus according to claim 1, wherein
the impression cylinder is formed in a larger diameter than a cylinder diameter of a transport cylinder, and
the sheet holding means is disposed within the notch portion of the impression cylinder so that the sheet holding means holding the sheet does not protrude from the outer peripheral surface of the impression cylinder.

18. The liquid supply apparatus according to claim 1, wherein
the sheet holding means comprises a gripper and a gripper pad for holding the sheet, and
the gripper and the gripper pad are disposed within the notch portion of the impression cylinder such that a holding surface of the gripper and a holding surface of the gripper pad, which contact the sheet, are inclined to a lower position toward a leading end of the sheet, and so that the gripper and the gripper pad holding the sheet do not protrude from the outer peripheral surface of the impression cylinder.
